(19) United States
(12) Patent Application Publication
(10) Pub. No.: US 2021/0370200 A1
(43) Pub. Date: Dec. 2, 2021

(54) WATER TREATMENT DEVICE CONSTRUCTION STRUCTURE HAVING GRATING ROOM AND METHOD FOR CONSTRUCTING VARIOUS WATER SPACES/WATERSCAPING FACILITIES HAVING SAME COUPLED THERETO

(71) Applicant: NF CO., LTD., Soeul (KR)

(72) Inventor: Jung Ho Woo, Seoul (KR)

(21) Appl. No.: 16/322,647

(22) PCT Filed: Aug. 3, 2017
(86) PCT No.: PCT/KR2017/008393

§ 371 Date: Feb. 1, 2019

(30) Foreign Application Priority Data
Aug. 4, 2016 (KR) 10-2016-0099568
Sep. 30, 2016 (KR) 10-2016-0127007

(51) Int. Cl. B01D 24/10; C02F 1/00; B01D 24/00; E02D 29/045

(52) U.S. Cl. CPC B01D 24/10; C02F 1/004; C02F 2103/001; E02D 29/045; B01D 24/001

(57) ABSTRACT

A water treatment device construction structure having a grating room and a method for constructing various water spaces/waterscape facilities having the same coupled thereto are disclosed. The structure relates to a buried water treatment device for treating operation water such as tap water, groundwater, rainwater, and surface water through an environment-friendly method. A water treatment device construction structure having a grating room is coupled to civil engineering/landscaping facilities, or to fish farms that are to be constructed in view of the purpose of construction and productivity. The water treatment facility having a reservoir coupled thereto is provided in a predetermined position below facilities or on the lower-end or peripheral portion thereof in a buried/underground type. Accordingly, there is no burden in site selection; a large amount of operation water can be stored without degrading the aesthetic landscape; and natural energy can be used preferentially.

### BACKGROUND

### Technical Field

The present disclosure relates to a construction structure of a water treatment device having a grating room and a method for constructing various water space/waterscape facilities having the construction structure coupled, in which the construction structure of the water treatment device having the grating room includes an object in a construction field of civil engineering/landscaping facility (hereinafter; referred to as “a facility”) including a filter paper that purifies quality of operation water (hereinafter; referred to as “operation water”) such as water, underground water, rainwater, and surface water, or a self-support and buried type environment-friendly water treatment structure formed on a contact ground, various kinds of pond type water spaces such as various types of water tanks, storage tanks made for various purposes, various types of water storage basins as waterfront facilities, artificial lakes, ponds, wetland, moorings, and the like, and waterscape facilities that use water such as artificial falls, basin, cascades, ground fountains, swimming pools, pools, and the method for constructing various water spaces/waterscape facilities is performed for presenting and maintaining microorganisms viable in fish farms in which a productivity thereof may be considered, and comprises the steps of proliferating, maintaining, preserving the microorganism in the fish farms or the composition in the fish farms.

### Background Art

Generally, various types of water baths, water tanks, water spaces, waterscape facilities, and waterfront facilities are constructed in various types of fish farms, parks, golf courses, amusement parks, and housing sites/apartment complexes, and the like as the object of production and civil engineering/landscaping facilities.

These “facilities” in the civil engineering/landscaping/ecological industry areas mainly use water or groundwater, rainwater and surface water. An installation and management of such a facility have the following problems.

First, conventionally, as a large amount of water or groundwater are used as “the operation water” of “the facility”, a lot of maintenance and management costs are incurred. That is, because of due to natural evaporation and pollution of “the operation water”, and the like, continuously supplying the water or the groundwater is costly.

Second, “the facilities” are combined with purification or purging device for water quality management, but “the operation water” may be easily polluted as the operation water is exposed to an external environment. When circulation and purification of the operation water are not smooth, the operation water is easily polluted and decayed and has a bad smell.

As a method for solving such a problem, conventionally, the water is exchanged in “the facilities” or “the facilities” is cleaned or “the operation water’ is purified by using a biological treatment a chemical method such as separation of solid particles from liquid or separation of liquid from solid, which is different from precipitation or filtration. In this case, a problem of secondary pollution due to by-products is also generated. Further, a general water treatment facility is installed additionally for the purification of “the operation water”. In this case, as capacity and performance of the water treatment facility are not quantitatively provided, it costs a lot in maintenance and there is a difficulty in management with respect to “the facilities”.

### SUMMARY

### Technical Problem

The present disclosure is related to using rainwater and surface water first as the operation water, which are natural energy, than water and groundwater of deep well in consideration of economic feasibility and enables water collection/accumulation, purification, circulation, and use of various kinds of operation water including the rainwater be smoothly made.

The present disclosure further provides construction technology as environment-friendly construction method of a water space/a waterscape facility that enables continuous maintenance by storing/storing “the operation water” to “the facility” along an introduction path by means of passing through of water and permeability and enhancing performance of purification of the water treatment facilities with respect to “the operation water”.

### Technical Solution

In order to achieve the above-mentioned object, the present disclosure provides a construction structure of a water treatment device including a storage tank, a contact material filled in the storage tank and stacked with a natural material and a porous filtration material that purify operation water introduced from a facility, a grating room that is provided to be surrounded by the contact material and the operation water introduced to the contact material is stored and at least one surface of which is formed in a grating shape, and a suction facility line provided as a means to purify, circulate, and use the operation water stored in the grating room.

It is preferable that one or more grating rooms are stacked in a direction crossing one another. A lower surface of the grating room may be formed in a grating shape.

According to the present disclosure, the construction method may further include at least one of a boundary contact material stacked on the contact material and a lower cover soil paved on a bottom of the storage tank so that the grating room may be easily placed.

The suction installation line may include a pumping means that circulates the operating water to the facility.

The present disclosure provides a method for constructing a water space/waterscape facility, including: excavating the ground at a height less than or greater than or a same height as the facility, forming the storage tank on the excavated ground, arranging a grating room on the storage tank in which at least one surface of which is formed in a grating shape, connecting the suction installation line to the grating room, and filling the contact material around the grating room.

Arranging the grating room having at least one surface being formed in the grating shape on the storage tank includes stacking at least one of grating rooms on the storage tank in a direction of crossing one another.

Arranging the grating room having at least one surface being formed in the grating shape on the storage tank includes arranging the grating room having a lower surface being formed in the grating shape on the storage tank.

The method for constructing the various types of water space/waterscape facilities having the construction structure coupled may further include at least one of forming the storage tank on the excavated ground, stacking the lower cover soil on the storage tank, filling the contact material around the grating room, stacking the boundary contact material on the contact material.

### Advantageous Effects

The present disclosure provides a buried and underground type construction structure according to the present disclosure under; at a lower end or at a predetermined position of a periphery of the facilities and enables solving a burden of a site selection and storing a large amount of operation water without degrading a great view of landscape and exerting excellent field applicability that uses natural energy first.

Further, according to the present disclosure, engineering facility technology is combined throughout the facilities to provide circulation, recovery, storage, and purification of the operation water with high efficiency. Therefore, continuity, convenience, and economic feasibility of maintenance may be enhanced and an environmental pollution may be prevented through the water quality purification and the operation water (water resources) may be greatly saved.

### BRIEF DESCRIPTION OF THE DRAWINGS

FIG. 1 is a plan view of a construction structure in which a storage tank is provided as a buried and underground type according to the present disclosure.

FIG. 2 and FIG. 3 are side cross-sectional views of a construction structure in which a storage tank and a water treatment device are coupled in underground according to the present disclosure.

FIGS. 4 to 6 are perspective views of a modified grating room in a construction structure of a water treatment device according to the present disclosure.

FIG. 7 is a side cross-sectional view of a construction structure according to an embodiment of the present disclosure installed under; at a lower end of a pond type “facility” such as artificial lakes, ponds/wetland, artificial falls.

FIG. 8 is a plan view of a construction structure installed under; at a lower end of a pond type “facility” such as artificial lakes, ponds/wetland, and artificial falls of FIG. 7 to which the present disclosure is applied.

FIG. 9 is a plan view of a construction structure according to yet another embodiment of the present disclosure, in which the construction structure is spaced apart from a pond type “facility” such as ponds and installed around the pond type “facility” such as pond and connected thereto.

FIG. 10 is a side cross-sectional view of a construction structure according to the present disclosure installed at the periphery of the pond type “facility” such as the pond of FIG. 9.

FIG. 11 is a plan view of a construction structure according to another embodiment of the present disclosure that is installed at a lower end of a facility such as moorings and having a function for recovering operation water.

FIG. 12 is a side cross-sectional view of a construction structure according to the present disclosure installed at a lower end of a facility such as the mooring of FIG. 11 and having a recovery tank for operation water.

FIG. 13 is a plan view of a construction structure according to yet another embodiment of the present disclosure that is provided at a periphery of a space which is spaced apart from storage basins for rainwater as waterfront facilities, and “facilities” such as ponds and coupled to “facility”.

FIG. 14 is a plan view of a detailed construction structure and an embodiment of the present disclosure of FIG. 13.

FIG. 15 is a side cross-sectional view of a construction structure according to another embodiment of the present disclosure that is coupled under; at a lower end of waterscape facilities such as ground fountains among “facilities” that use water and has a recovery tank for operation water.

FIG. 16 is a plan view of a construction structure according to an embodiment of the present disclosure that is coupled under; at a lower end of the waterscape facilities such as ground fountains among “facilities” that use water and has a recovery tank for operation water.

FIG. 17 is a side cross-sectional view of a construction structure according to yet another embodiment of the present disclosure that is coupled under; at an end of waterscape facilities such as cascades among “facilities” that use water and has a recovery tank for operation water.

FIG. 18 is a plan view of a construction structure according to an embodiment of the present disclosure that is coupled under; at a lower end of waterscape facilities such as cascades among “facilities” that use water and has a recovery tank for operation water.

FIG. 19 is a side cross-sectional view of another embodiment in which culvert, buried, and underground type construction structure is provided at roadsides among embodiments in which construction structures may be selectively provided in places such as roadsides, green belts (squares), parking lots, and the like.

### DETAILED DESCRIPTION

Hereinafter, embodiments of the present disclosure will be described in detail with reference to the drawings.

However, the present disclosure may be implemented in many different manners and should not be construed as limited to the embodiments set forth herein. Rather, these embodiments are provided so that this disclosure will be thorough and complete, and will fully convey the scope of the present disclosure to those skilled in the art Like reference numerals refer to like elements.

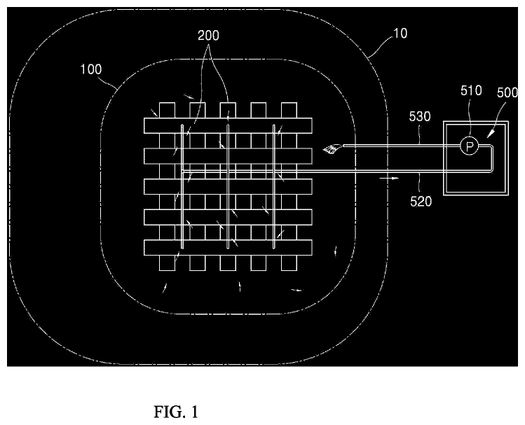

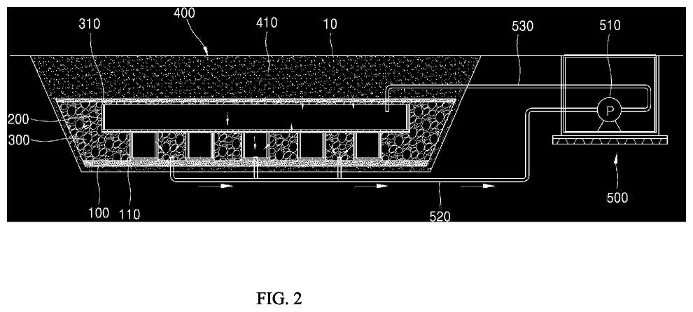

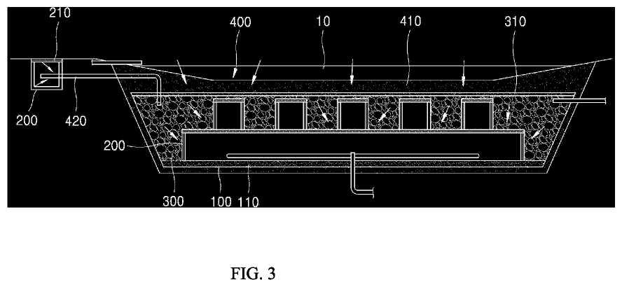

FIG. 1 is a plan view of a construction structure in which a buried and underground type storage tank is provided according to the present disclosure, and FIGS. 2 and 3 are side cross-sectional views of a construction structure according to the present disclosure in which a storage tank and a water treatment device are combined in underground.

According to the present disclosure, as shown in FIGS. 1 to 3, a construction structure of a water treatment device having a grating room includes a storage tank 100 that stores operation water introduced from a facility, a grating room 200 provided in the storage tank 100, and a contact material 300 filled in an inner space of the storage tank 100 so as to surround the grating room 200. The present disclosure further includes a facility device that uses purification water in which the operation rater is water treated in the storage tank 100 and purifies the operation water introduced to the storage tank 100 and circulates the purified operation water to the facility. At this time, the facility device may include a pumping means 500.

The facilities described in the present disclosure includes at least one of civil engineering, landscaping including parks, golf courses, amusement parks, and housing sites, fish farms made for a productive purpose, a civil engineering facility including storage tanks for rainwater, inundated water storage basins, waterfront facilities at roadsides, or landscaping/waterscape facilities including artificial lakes, ponds, wetland, moorings, waterfalls, basin, cascades, ground fountains, and green belts. Further, the facilities use natural water and surface water including rainwater as the operation water.

The storage tank 100 stores the operation water while preventing leakage of the operation water being introduced into the facility. To this end, the storage tank 100 is constructed in a form of waterscape green belt in which the ground is excavated at a height of less than or greater than or a same height as a facility at a periphery or a lower portion of the facility and arbor, shrub, ground cover plants are planted in a state in which the upper portion is covered or the ground is covered with soil. Further, the excavated ground is waterproofed, thereby preventing the operation water from being leached to the excavated ground and damaged. To this end, the storage tank 100 may be formed of a waterproof sheet or may be formed of a concrete placing body. The storage tank 100 may have a size corresponding to an area of the facility, but this is not limited thereto. That is, the size of the storage tank 100 may be set depending on the amount of operation water introduced from the facility. Further, a lower cover soil 100 for flattening may be paved so that the grating room 200 may be stably installed at a bottom of the storage tank 100. It is preferable to use loam as medium-texture or a crushed stone having a small particle size as a lower cover soil 110. Meanwhile, when the lower cover soil 110 is constructed, it is preferable to simultaneously perform the construction of a suction installation line 520 of a pumping means 500 to be described later.

The grating room 200 is arranged in underground, that is, in the storage tank, and forms a space so that the operation water may be smoothly introduced and may go out throughout an entire surface thereof. The grating room 200 provides a space in which the operation water purified by the contact material 300 is introduced into the grating room and stored. As shown in the drawings, according to the present disclosure, the grating room 200 is implemented in a rectangular shape, but is not limited thereto. That is, the grating room 200 may be a polyprism shape including a cylindrical shape and a cylindroid shape. In this embodiment, the grating room 200 is formed in a grating shape for whole six surfaces or a surface except for a part thereof so that an introduction of the contact material from the outside is prevented, and the purified operation water may be smoothly introduced. That is, according to the embodiment, all surfaces of the grating room 200 are formed in a grating shape. However, the present disclosure is not limited thereto. The lower surface of the grating room 200 may only be formed in the grating shape, and the operation water may not be introduced to the remaining surface, thereby maximizing purification efficiency of the operation water. As a distance in which the operation introduced to the grating room 200 passes through the contact material 300 is greater, the purification efficiency of the operation water is increased. Of course, it is also possible to allow the operation water not to be introduced to the upper and lower surfaces of the grating room 200 and to be only introduced to the side of the grating room 200. The grating room 200 may be arranged in various forms, as shown in FIGS. 1 and 2. However, as a preferable embodiment, the grating room 200 may be arranged with two or more layers in a vertical direction, and may be installed in various shapes and angles, including the case in which the grating room provided at the upper portion has a right angle to the grating room provided at the lower portion. On the other hand, as described above, according to the present disclosure, various pillar shapes may be applied and the shapes deformed to withstand a load applied to the upper portion of the grating room may be applied.

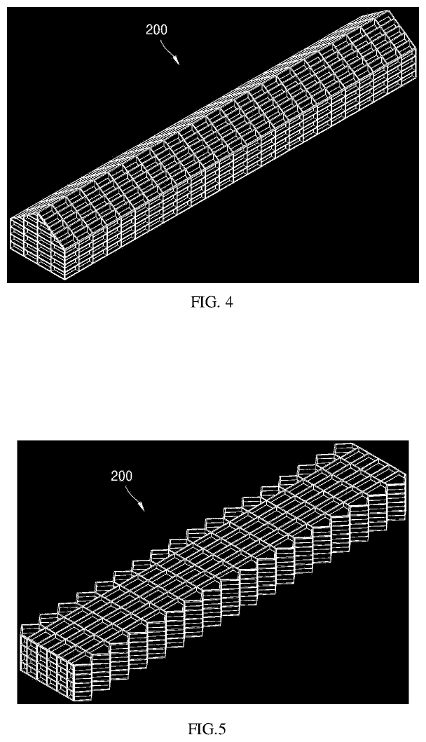

FIGS. 4 to 6 are schematic perspective views of a grating room according to a modification of the present disclosure. FIGS. 4 to 6 an enlarged view of a grating of a grating room for convenience. Actually, the grating of the grating room is made in such a sufficiently small size that a contact material 300 is not introduced into the grating room.

According to the present disclosure, as shown in FIG. 4, an upper surface of a grating room 200 may protrude. A storage space of the operation water is enlarged and a weight applied to the grating room 200 from the ground is dispersed. The load applied to the upper portion of the grating room 200 is applied to a periphery of the grating room 200 due to an upper form of the grating room 200 protruding upward.

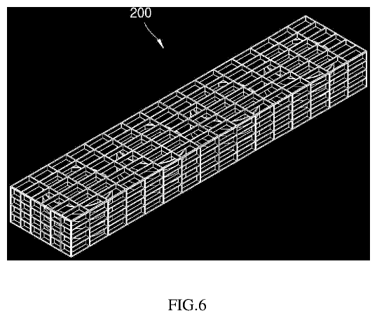

Further, according to the present disclosure, as shown in FIG. 5, the side of a grating chamber 200 may be corrugated in a zigzag shape so that the load applied to the upper portion of the grating chamber 200 may be more easily withstood by the side of the grating chamber 200.

Further, according to the present disclosure, as shown in FIG. 6, a grating room in a cylindrical shape may be in a grating room 22 in a square pillar shape. In this case, a load applied to the upper portion of the grating room 200 may be more easily withstood. According to the present disclosure, the corrugated side of the grating room 200 shown in FIG. 5 may be applied to the embodiment shown in FIG. 6. In this case, the side of the grating chamber 200 is corrugated, and a cylindrical grating room is in the grating room 200. Further, the cylindrical grating chamber in the grating room 200 may have a cylindroid shape or a polyprism shape in addition to a cylindrical shape.

The contact material 300 is filled in an inner space of the storage tank 100 except for the grating room 200 and purifies the operation water introduced to the storage tank from the facility. In other words, the contact material 300 filters the operation water inundated into the storage tank from the facility and naturally purifies the operation water. The contact material 300 may be used in various types, and thermosetting ceramics, various kinds of natural minerals, and porous natural materials may be used. That is, the contact material 300 uses charcoal, ceramic, mineral, a crushed stone, and a natural material as a porous filtration material, and enables physical, chemical, and biological water quality purification mechanism while the operation water passes through the contact material 300. As shown in FIGS. 2 and 3, the contact material 300 may include a boundary contact material 310. The boundary contact material is covered on the contact material 300 and is paved in a constant thickness so that an upper finishing cover soil 510 is not flowed under the contact material 300.

Meanwhile, the present disclosure may further include means of introducing operation water 400 between the facility 10 and the contact material 300.

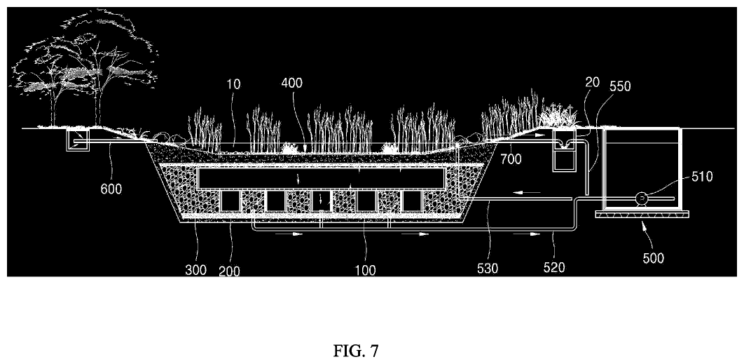

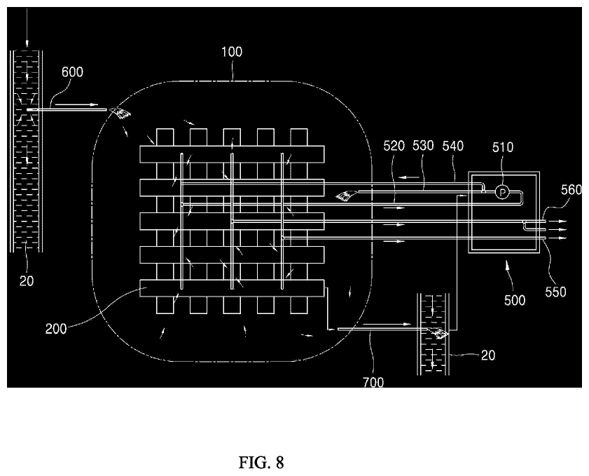

The means of introducing operation water 400 allows the operation water to be introduced to the storage tank from the facility and allows the operation water to be naturally introduced to an upper open space of the storage tank 100 and inundated into the grating room as shown in FIG. 3, or to be directly introduced to the grating room along a pipe line as shown in FIG. 7, 8, or 19. At this time, in the former case, a means of introducing operation water 400 is provided at the upper open portion of the storage tank 100. In the latter case, the means of introducing operation water 400 is provided on the upper portion at a periphery of the facility storage tank 100. Of course, the former and latter means of introducing operation water 400 may be suitably applied in combination thereof.

As shown in FIG. 3, according to the embodiment, an upper finishing cover soil 410 that is paved on the storage tank 100, forming a boundary, and filters a primary pollutant or a direct water supply pipe 420 that is connected to the upper portion of the storage tank at the periphery thereof from the storage tank and has a filter 210 that filters a primary pollutant at an end of the facility are selectively installed as the means of introducing operation water 400. The upper finishing cover soil 410 is covered and flattened on the boundary contact material 310 and is formed between the bottom of the facility and the boundary contact material, while the upper finishing cover soil 410 makes the operation water be smoothly inundated through the bottom of the facility. Thus, it is preferable to use granite soils as a material of the upper finishing cover soil 410.

The pumping means 500 suctions the purified operation water from the lower portion of at least one of the grating room 200 and the contact material 300 and circulates the suctioned operation water to the facility 10. To this end, according to the embodiment, the pumping means 500 may include a pump 510 installed in a different space from the storage tank 10 and spaced from the storage tank 100 to forcibly circulate the operation water, a suction facility line 520 that is connected to an upper portion of at least one of the grating room and the contact material through the storage tank form the pump and suctions the purified operation water, and a water quality purification and circulation facility line 530 that is connected to the facility from the pump and circulates the operation water in the storage tank or circulates to an outside of the storage tank. At this time, as shown in the figure, the pump 510 is installed in a pump room at one side of the facility 10, so that the pump 510 may be safely protected, and the upper portion of the pump room may be easily opened and inspected and repaired if necessary. As shown in FIGS. 1 to 3, the suction facility line 520 includes a suction pipe installed inside of at least one of the grating rooms and the contact material, and suctioning the purified operation water through a plurality of suction ports. That is, the operation water purified inside of at least one of the grating room and the contact material may be uniformly suctioned through the suction pipe.

According to the present disclosure, various kinds of water spaces and waterscape facilities having the construction structure of the water treatment device having the grating room combined will be described. The contents overlapping with the description of the construction structure of the water treatment device having the grating room according to the present disclosure described above will be omitted or briefly described.

FIG. 7 is a side cross-sectional view of a construction structure according to an embodiment of the present disclosure installed under; at a lower portion of a pond type “facility” such as artificial lakes, ponds/wetland, artificial falls. FIG. 8 is a plan view of a construction structure installed under; at a lower end of the pond type “facility” such as artificial lakes, ponds/wetland, artificial falls of FIG. 7 to which the present disclosure is applied.

As shown in FIGS. 7 and 8, according to the present disclosure, the construction structure of the water treatment device having the grating room may include a pond type facility such as an artificial lake, a pond/a wetland, and artificial falls as a facility 10. In this case, the pond type facility 10 is installed at an upper portion of a contact material 300, and the operation water is introduced to the contact material 300 from the facility 10. Further, there may be water resources such as natural valley around the facility 10 or rainwater introducing pipe 600 may be connected to the contact material 300 through a manhole for rainwater 20. Of course, the present disclosure is not limited thereto, and it is also possible to directly connect the rainwater introducing pipe 600 to the contact material 300. As described above, the operation water introduced to the contact material 300 is introduced to the grating room 200. The operation water introduced to the grating room 200 is circulated to the facility through the suction facility line 520 and a water quality purification and circulation facility line 530 and purified when the pumping means 500 is operated. Further, according to the present disclosure, an operation water overflow pipe 700 is provided, and the operation that exceeds the capacity of the facility 1—may be introduced to the manhole for rainwater 20 through the operation water overflow pipe 700.

Further, in this embodiment, as shown in FIG. 8, the pumping means 500 may further include a backwashing facility line 540 connected to the suction facility line 520. In this case, the backwashing facility line 540 not only eliminates clogging of the suction pipe by recirculating the operation water pumped by the pump 510 to the suction pipe of the suction facility line 520 described above but also removes the foreign matters attached in the grating room and to the contact material around the grating room. As shown in the figure, as the backwashing facility line 540 is connected in adjacent to an outlet of the pump 510 with a water quality purification and circulation installation line 530, it is preferable that the opening and closing valves are installed in the water quality purification and circulation facility line 530 and the backwashing facility line 540, respectively, to be selectively used if necessary.

Further, as shown in FIGS. 7 and 8, the pumping means 500 may include a water discharge facility line 550 that discharge the operation water to a manhole, a drain pipe or a stream. The water discharge facility line 550 may control a water level of the grating room by forcibly discharging the water inside of the grating room 200.

Further, as shown in FIG. 8, the pumping means 500 may include a facility line of using operation water 560 that supplies water to landscaping trees or landscaping flowers. That is, the water is supplied to landscaping trees or landscaping flowers in roads or residential areas using the facility line of using operation water 560 of the pumping means 500, and is also used for wastewater reuse system.

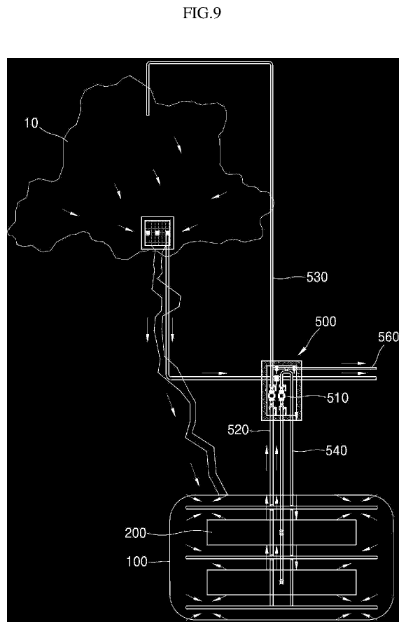

On the other hand, as shown in FIG. 8 or 9, the pumping means 500 may further include one or more pumps 510 connected to the backwashing facility line, the water discharge facility line or the facility line of using the operation water. In this case, two or more pumps 510 may be provided, and each of the pumps may be selectively connected to each installation line and may be independently driven.

In the embodiment having such a configuration, FIGS. 7 and 8 show that a parks, golf courses, amusement parks, ecological ponds constructed in an apartment complex or ecological wetland are applied as a facility 10. An environment of the ecological pond is created so that organisms or flowers grow. As shown in the figure, the ecological pond has a bottom and an inclined surface formed of loam and is configured so that flowers including various kinds of aquatic plants and landscaping stone are provided at the bottom and the inclined surface. According to the present disclosure, the water treatment facility is constructed under the ecological pond. Before the ecological pond is constructed, the lower portion of the bottom of the biological pond is excavated deeply and broadly, and then, the storage tank 100, the grating room 200, the contact material 300, a means of introducing operation water 400 in a shape of an upper portion finishing cover soil, and a pumping means 500 are constructed in the excavated space. Further, a rainwater introducing pipe 600 and overflow pipe for operation water 700 are constructed to be connected to the ecological pond. Meanwhile, a separate pump room is provided in ground and at least one of pumps 510, for example, two or three pumps 510 are provided therein, and a suction facility line 520, water quality purification and circulation facility line 530, backwashing facility line 540, water discharge facility line 550 or facility line of using operation water 560 are selectively connected to each pump 510.

According to the configuration of the present disclosure, the rainwater or water or groundwater of deep well as the operation water are introduced to a pond first, and the operation water introduced to the pond penetrates the bottom and is collected in the grating room 200 as the operation water passes the contact material 300 through the upper finishing cover soil 410 as the means of introducing the operation water 400. As the inundating through the bottom of the pond is gradually made, pre-treatment and purification of the operation water is made through the upper finishing cover soil 410 and the contact material 300. When a sufficient amount of operation water is stored in the grating room 200, the pump 510 is operated to circulate and purify the operation water through the suction facility line 520 and the water quality purification and circulation facility line 530 to move the operation water back to the ecological pond, or the water is supplied to a surrounding flowers or trees through the facility line using the operation water 560. On the other hand, when the grating room 200 is cleaned, inspected, and repaired, and the water level is adjusted if necessary, the water may be discharged to the manhole or the river through the water discharge facility line 550 when the water is forcibly drained.

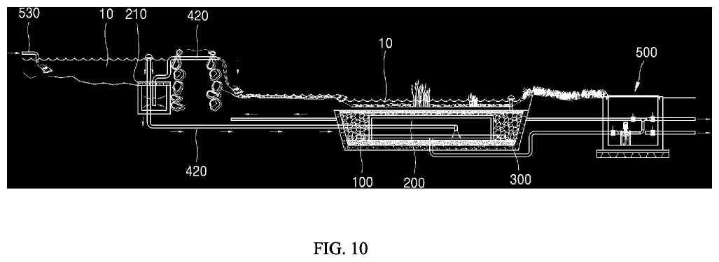

FIG. 9 is a plan view of a construction structure according to yet another embodiment of the present disclosure, in which the construction structure is spaced apart from a pond type “facility” such as a pond by a predetermine distance and is installed at a periphery of the pond type “facility” such as a pond and connected thereto. Further, FIG. 10 is a side cross-sectional view of a construction structure according to the present disclosure, in which the construction structure is installed at a periphery of pond type “facility” such as the pond of FIG. 9.

As shown in FIGS. 9 and 10, the present embodiment illustrates that a storage tank is buried in a lower periphery of a pond, which is a facility 10. In this case, the pond is formed at an upper region of the river (hereinafter, referred to as “an upper pond”), and a storage tank 100 is buried in a low region of the river. The operation water is flowed into the storage tank which is in low zone from the pond which is in high zone so that a separate pond (hereinafter; referred to as “a lower pond”) is formed at the upper portion of the storage tank. According to this structure, in this embodiment, the operation water stored in the grating room is sent to the upper pond, and the operation water forms waterfalls or a waterway in the upper end, so that the operation water is introduced to the lower storage tank and recovered.

On the other hand, in the upper pond, a water collector is installed at the bottom of the upper pond as the means of introducing operation water 400 and a filter 210 that filters a primary pollutant is formed at an upper portion of the water collector and a direct water supply pipe 420 that directly supplies the overflowed operation water to the storage tank 100 in the water collector. At this time, the operation water introduced to the grating room 200 through the direct water supply pipe 420 is circulated back to the pond by a pumping means 500, so that the operation water flows in the storage tank 100. As such a flow is made through the contact material 300, the operation water is purified. Further, in this case, the operation water may be leached into the storage tank 100 through an upper finishing cover soil 410 as a means of introducing the operation water 400 in the lower pond. In the lower pond, the upper surface thereof is not opened as the water space depending on object and usage of the facility. As shown in FIG. 2, the upper finishing cover soil 410 may be paved thinner so that a waterscape greenbelt park is created, in which arbor, shrub, ground cover plants may be planted.

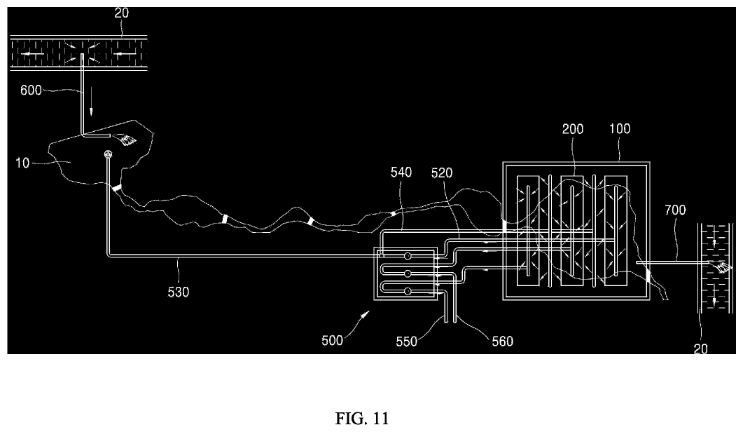

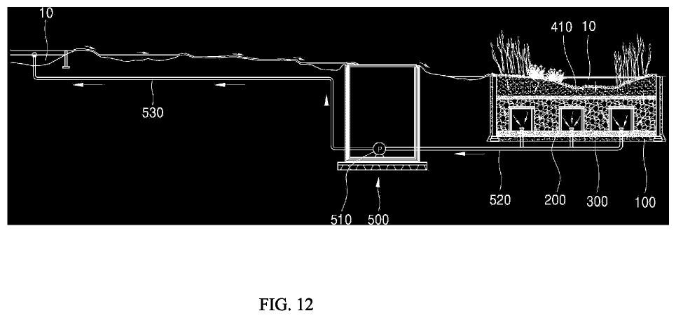

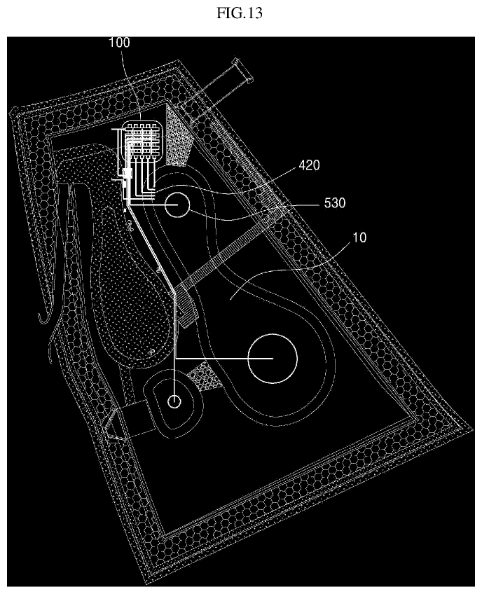

FIG. 11 is a plan view of a construction structure according to another embodiment of the present disclosure, in which the construction structure is installed at a lower end of the facilities such as moorings and has a recovery function of the operation water. FIG. 12 is a side cross sectional view of a construction structure according to the present disclosure, in which the construction structure is installed at a lower end of the facility such as mooring and has a recovery tank for the operation water.

As shown in FIGS. 11 and 12, the present embodiment is applied to a mooring constructed in a park, a golf course, an amusement park, or an apartment complex as a facility 10. The mooring is a form of stream, and a head is formed on an upper portion of the stream, which is in the high zone of the stream, and a reservoir is formed at a lower portion of the stream, which is in the low zone of the stream. Further, a waterway and overflow trap are formed in various forms between the head and the reservoir.

In this embodiment, before the reservoir of the mooring is constructed, the lower portion of the bottom is excavated deeply and broadly, and a storage tank 100 in a concrete placing body or waterproofing sheet, a grating room 200, a contact material 300, a means of introducing operation water 400 in a form of upper finishing cover soil, and a pumping means 500 are constructed in the excavated space. The storage tank 100 in the concrete placing body or waterproofing sheet, the grating room 200, the contact material 300, the means of introducing operation water 400 in a form of upper finishing cover soil, and the pumping means 500 are constructed under the reservoir of the mooring. On the other hand, at least two or three pumps 510 are provided and a separate pump room is provided, and at least two or three pumps 510 are installed in the pump room. A suction installation line 520, a water quality purification and circulation installation line 530, a backwashing installation line 540, a water discharge installation line 550 or a facility line of using the operation water 560 are selectively connected to each of these pumps, respectively. It is preferable that the water quality purification and circulation installation line 530 is connected to the head of the mooring and the operation water overflow pipe 700 is formed in the reservoir.

In this embodiment, according to such a configuration, the rainwater or water or the ground water of deep well is introduced to the mooring first as the operation water and the introduced operation water penetrates the bottom of the reservoir, and is purified through the upper finishing soil cover 410 as the means of introducing operation water 400 and the contact material 300, and the purified operation water is collected in the grating room 200. At this time, as the operation water is slowly inundated into the grating room 200 through the operation water introducing means 400 as the bottom of the reservoir, the operation water is purified through the upper finishing soil cover 410 and the contact material 300. As described above, when a large amount of operation water is stored in the grating room, the pump 510 is operated so that the operation water is moved back to the head through the suction installation line 520 and the water quality purification and circulation installation line 530 or the water is supplied to surrounding flowers or tress through the facility line of using the operation line 560. On the other hand, when the water is forcedly discharged out of the grating room, the water is discharged to the manhole for rainwater pipe or stream through the water discharge installation line 550.

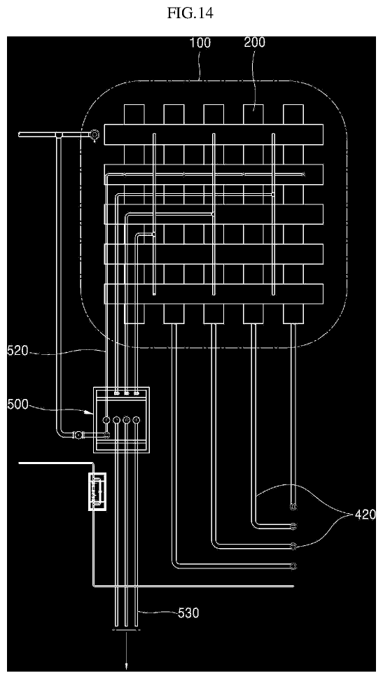

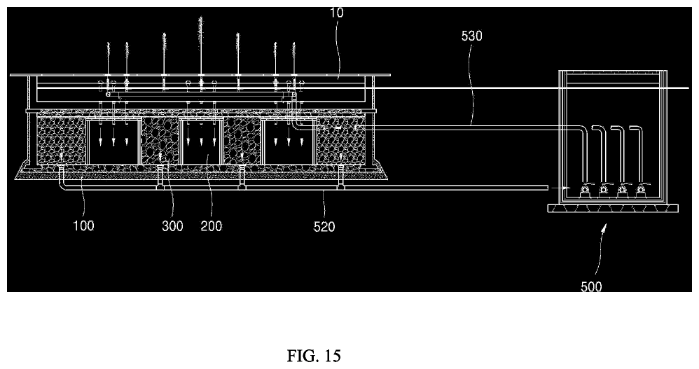

FIG. 13 is a plan view of a construction structure according to another embodiment of the present disclosure, in which the construction structure is provided around a space spaced apart from “a facility” such as pond as a waterfront facility and storage basin for rainwater and connected to “the facility”. Further, FIG. 14 is a plan view of an embodiment of FIG. 13 in detail.

As shown in FIGS. 13 and 14, in the present embodiment, an example in which a periphery spaced apart from the facility 10 is buried and constructed is applied.

Therefore, in the rainwater storage basin, the direct water supply pipe 420 that directly supplies the operation water to a storage tank 100 is formed as a means of introducing operation water 400. The plurality of direct water supply pipes 420 are provided, and the plurality of direct water supply pipes 420 are connected to each grating room, respectively, from the water storage basin. At this time, the operation water introduced to the grating room 200 through the direct water supply pipe 420 is circulated back to the water storage basin by a pumping means 500, so that a flow of operation water occurs in the storage tank 100. As such a flow is made through a contact material 300, the operation water is purified.

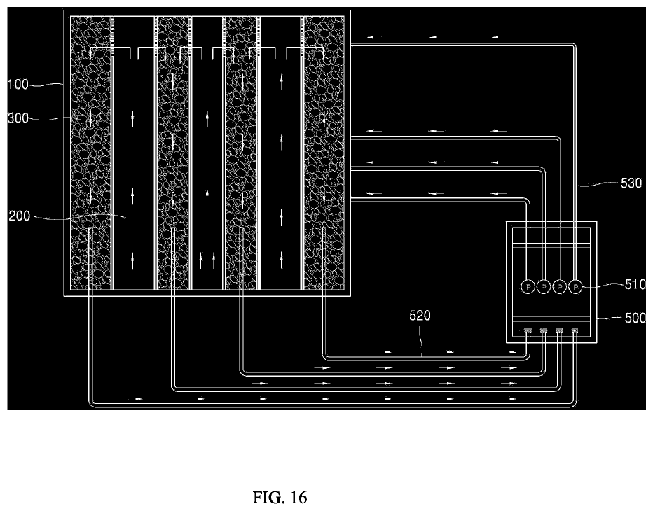

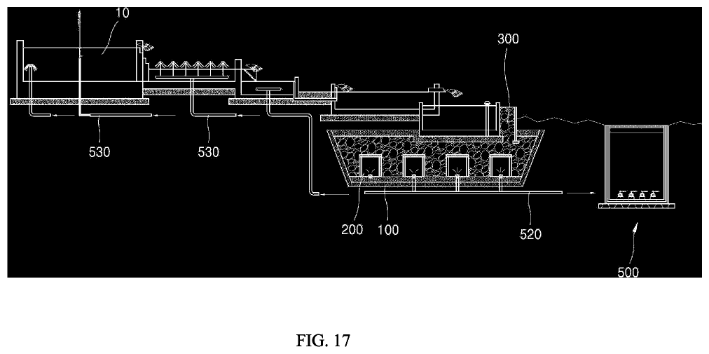

FIG. 15 is a side cross-sectional view of a construction structure for water quality purification according to another embodiment of the construction structure coupled under; at a lower portion of waterscape facilities such as ground fountains among “the facilities” that use the water. FIG. 16 is a plan view of an embodiment of a construction structure coupled under; at a lower end of waterscape facilities such as ground fountains such as “facilities” that use water and a plan view of a construction structure of water quality purification according to the present disclosure.

As shown in FIGS. 15 and 16, according to the embodiment, the ground fountain is a facility 10, and a storage tank is buried at the lower portion of a ground fountain. In this case, as the circulation of the operation water may be performed smoothly, a means of introducing operation water in the form of a direct water supply pipe may be provided between the ground fountain and a storage tank 100 in the upper portion of the ground fountain. Further, a pumping means 500 includes a pump 510 corresponding to each grating room 200, a plurality of suction installation lines 520 connected to each grating room 200, a plurality of water quality purification and circulation installation line 530 connected to each nozzle from each pump are provided. At this time, the operation water introduced to the grating room 200 through the means of introducing the operation water in the form of a direct water supply pipe is circulated back to the ground fountain by the pumping means 500, so that a flow of the operation water occurs in the storage tank 100. As this flow is made through the contact material 300, the operation water is purified. On the other hand, as shown in the figure, a nozzle or a sprinkler for the fountain may be installed at the end of the water quality purification and circulation facility line 530.

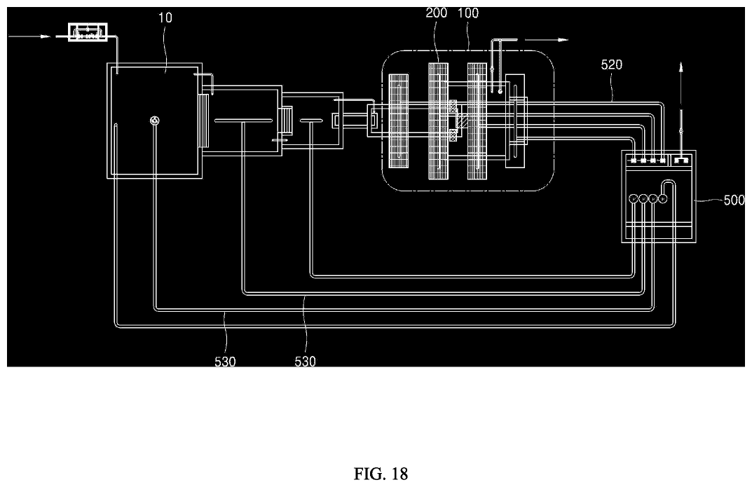

FIG. 17 is a side cross-sectional view of a construction structure according to yet another embodiment of the present disclosure that is coupled under; at an end of waterscape facilities such as cascades among “facilities” that use water and has a recovery tank for operation water. Further, FIG. 18 is a plan view of a construction structure according to an embodiment of the present disclosure that is coupled under; at a lower end of the waterscape facilities such as cascades among “facilities” that use water and has a recovery tank for operation water.

As shown in FIGS. 17 and 18, in an embodiment, a facility 10 includes a cascade, and a storage rank is buried in a lower part of the cascade. In this case, the embodiment of the mooring and the embodiment of the ground fountain are combined. That is, a storage tank 100 is buried in the lower portion of the cascade, and the operation water is inundated into the storage room through the bottom of the cascade, and the operation water in the storage tank circulates to the upper portion of the cascade, while the operation water is circulated in the upper portion of the cascade is injected and the operation water is injected through a nozzle, like the ground fountain.

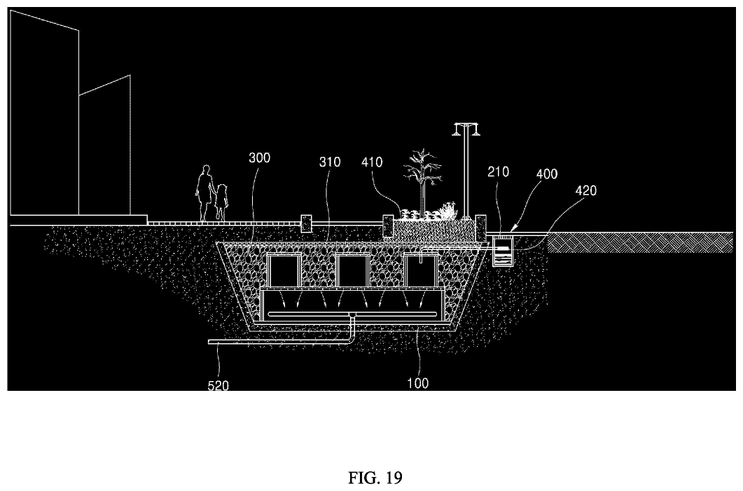

FIG. 19 is a side cross-sectional view of another embodiment of the present disclosure in which a culvert, buried, underground type construction structure is provided at roadsides among embodiments in which construction structure may be selectively provided in places of roadsides, green belts (squares), and parking lots.

As shown in FIG. 19, the present embodiment exemplifies the roadside as a facility 10, and a storage tank is buried in the lower portion of the roadside. In this case, as shown in the drawing, a manhole of a rainwater pipe is formed at an edge of the road so as to collect the rainwater as the operation water. Further, a direct water supply pipe 420 and a filter 210 are formed as the means of introducing operation water 400 to allow the operation water to be introduced to the storage tank through the manhole of the rainwater-pipe. When a landscaping space is formed due to vegetation on a sidewalk at an edge of the road, the rainwater is introduced to the storage tank as infiltration water from the vegetation space. Thus stored operation water is naturally purified through the function of the contact material and by the plant in the vegetation space and stored as the high quality of purification water, and may be supplied to landscaping tress such as plants or flowers around the road or may be supplied to a building as a wastewater reuse system.

Although the present disclosure has been described with reference to the accompanying drawings and embodiments, one of ordinary skill in the art appreciates that various modifications and changes can be made within a scope as set forth in claims below for the skilled person in the art.

1. A construction structure of a water treatment device of storing and circulating and purifying operation water for a civil engineering and/or landscaping facility, comprising:
a storage tank,
a contact material filled in the storage tank to purify the operation water of the facility,
at least one grating room surrounded by the contact material and formed as a space in which the operation water of the facility may be stored, and having at least one surface thereof formed in a grating shape; and
a facility device that circulates the operation water of the storage tank in the storage tank or to the facility,
wherein a center of an upper surface of the grating room protrudes and the upper surface of the grating room is inclined to both sides from the center of the protruding upper surface thereof, and a pillar is formed in the grating room, and a side of the grating room has a corrugated form in a zigzag shape based on a plan view.

2. The construction structure of the water treatment device of claim 1, wherein the at least one grating room comprises a plurality of grating rooms arranged with the upper portion of the grating rooms continuously stacked in a direction crossing each other.

3. The construction structure of the water treatment device of claim 1, wherein the facility comprises at least one of the group consisting of: a water space facility in a civil engineering field comprising a water tank, a storage tank, a storage basin for rainwater as waterfront facility, a fish farm, an artificial lake, wetland, a river, and/or a mooring; and a waterscape facility in a landscaping field comprising artificial falls, a basin, a cascade, a ground fountain, a swimming pool, and/or a pool.

4. A method for constructing a facility having a water treatment device coupled that stores, circulates, and purifies operation water of the facility using the construction structure of the water treatment device of claim 1, comprising:
excavating ground,
forming the storage tank at an excavated bottom,
arranging the at least one grating room having at least one surface thereof formed in a grating shape on the storage tank,
connecting the facility device that circulates the operation water of the storage tank in the storage tank or to the facility to the storage tank, and
filling the contact material around the grating room.

5. The method for constructing the facility of claim 4,
wherein arranging the at least one grating room having at least one thereof formed in the grating shape on the storage tank comprises stacking a plurality of grating rooms on the storage tank in a direction crossing each other.

6. The method for constructing the facility of claim 4, wherein the facility comprises at least one of the group consisting of a water space facility in a civil engineering field comprising a water tank, a storage tank, a storage basin for rainwater as a waterfront facility, a fish farm, an artificial lake, a pond, wetland, the river, and/or a mooring; and a waterscape facility in a landscaping facility comprising artificial falls, a basin, a cascade, a ground fountain, a swimming pool, and/or a pool.

7. The method for constructing the facility of claim 5, wherein the facility comprises at least one of the group consisting of a water space facility in a civil engineering field comprising a water tank, a storage tank, a storage basin for rainwater as a waterfront facility, a fish farm, an artificial lake, a pond, wetland, the river, and/or a mooring; and a waterscape facility in a landscaping facility comprising artificial falls, a basin, a cascade, a ground fountain, a swimming pool, and/or a pool.
